(19) United States
(12) Patent Application Publication
(10) Pub. No.: US 2007/0056665 A1
(43) Pub. Date: Mar. 15, 2007

(54) Anti-irregular wear device for tire tread

(75) Inventor: Jean-Francois Parmentier, Thiers (FR)

Correspondence Address: BUCHANAN, INGERSOLL & ROONEY PC, POST OFFICE BOX 1404, ALEXANDRIA, VA, 22313-1404, US

(73) Assignee: MICHELIN RECHERCHE ET TECHNIQUE S.A., GRANGES-PACCOT (CH)

(21) Appl. No.: 11/518,914

(22) Filed: Sep. 12, 2006

(30) Foreign Application Priority Data
Sep. 15, 2005 (FR) 05/09518

(51) Int. Cl. B60C 11/13

(52) U.S. Cl. 152/209.19; 152/209.15

(57) ABSTRACT

A tire tread comprising a tread pattern formed by elements in relief defined by at least two grooves of a width of generally circumferential orientation, at least one of said grooves comprising a plurality of anti-wear studs arranged substantially regularly in the longitudinal (circumferential) direction of the tread, each stud of a maximum height at its base being separate from its neighbors in the groove, each stud comprising an outer surface formed of lateral parts facing the walls of the tread pattern elements and an outer surface between said lateral parts, the outer surface of each stud comprising at least two contact surfaces substantially parallel to the running surface, these contact surfaces being offset radially towards the inside relative to the running surface and offset radially relative to one another in the direction of the height of the stud, the offset with regard to height between two successive contact surfaces of one and the same stud being at least equal to 25% of the maximum height of the stud.

The present application claims priority under 35 U.S.C. §119 to French Application Serial No. 05/09518 filed on Sep. 15, 2005.

### FIELD OF INVENTION

The object of the present invention is to improve the treads for tires intended to be fitted on heavy vehicles; it relates in particular to the tread pattern of these treads.

This invention is in particular, but not exclusively, intended to be used for radial-carcass tires designed for the non-driving axles of heavy vehicles.

As a general rule, such tires comprise a carcass reinforcement surmounted radially to the outside by a crown belt, itself surmounted by a tread. This tread is provided with a tread pattern formed substantially of ribs of generally circumferential orientation defined by grooves of the same orientation or blocks defined by circumferential grooves and transverse grooves or a combination of blocks and ribs.

### BACKGROUND OF INVENTION

In the case of a tread pattern having grooves of circumferential orientation, it has been noted that localized wear (known as “irregular wear”) may arise at the edges of the ribs surrounding certain of said grooves. This wear arises quite quickly and develops in a first phase of use of the tire; by first phase, we here mean distances of less than 30,000 km, which is a relatively low figure compared to the average distances over which a tire is used, which may reach 100,000 to 300,000 km or even more depending on travel and usage conditions.

To prevent the appearance of such irregular wear, it has been proposed to provide some of the grooves of a tread pattern with an “anti-wear” device, placed in the bottom of these grooves and extending in the direction of the thickness of the tread either as far as the level of the running surface in the initial state or slightly therebelow. In both cases, a differential wear mechanism appears between the neighboring ribs and the device interposed between these ribs, which maintains a small difference in level. This differential wear mechanism is the direct consequence of different rolling radii bringing about differential sliding between the ribs and the devices interposed between said ribs.

U.S. Pat. No. 448,0671 describes a tread pattern having in a groove an anti-irregular wear device in the form of a rib, this rib having a radially outer surface formed of a plurality of surfaces offset relative to one another.

However, these devices are imperfect in the sense that while, early in travel, the tangential forces exerted on the tire by the road are modified, it has been observed that, over time, the advantages of such devices disappear to the point that irregular wear may appear after 30,000 km and that after the appearance thereof this wear is maintained.

Another drawback which is sometimes observed lies in the fact that the outer surface of the device, which is initially offset towards the inside relative to the running surface of the tire or indeed at the same level as said surface, may become offset radially towards the outside, the expected effect on irregular wear then no longer being obtained.

The present invention proposes an improved device not having any of the drawbacks listed.

### SUMMARY OF THE INVENTION

The invention provides a tire tread provided with a running surface intended to be in contact with a roadway, this tread comprising a tread pattern formed by elements in relief defining at least two grooves of a width Lr and of generally circumferential orientation, at least one of said grooves comprising a plurality of anti-wear studs spaced substantially regularly in the longitudinal (circumferential) direction of the tread. Each stud, of a maximum height H, is separate from the neighboring studs in the groove and comprises an outer surface formed of two lateral parts facing the walls of the tread pattern elements in such a way that said stud is separate from said tread pattern elements. Each stud additionally comprises an outer surface linking said lateral parts, this outer surface being formed of at least two contact surfaces intended to come into contact with the ground during travel, these contact surfaces being offset radially towards the inside relative to the running surface and additionally being offset radially relative to one another in the direction of the height of the stud (i.e. in the direction of the depth of the groove), the offset with regard to height between two contact surfaces of one and the same stud being at least equal to 25% of the maximum height of the stud. This tread is characterized in that the length measured in the circumferential direction of the contact surface radially furthest to the outside of each stud is between 60 and 85% of the total circumferential length measured at the base of the stud.

Preferably, the tread is such that the studs in one and the same groove are spaced from one another by at least 2% of the average footprint length of the tire under its nominal operating conditions.

The nominal operating conditions are defined in particular by the ETRTO standard for each tire dimension.

Preferably, the offset with regard to height between the contact surface of each stud radially furthest towards the outside of said stud and the running surface of the tire is at most equal to 25% of the depth of the groove in which this stud is disposed. This arrangement makes it possible to make the tread pattern more resistant to cracking.

Preferably, the lateral parts of each stud are spaced in the transverse direction by at least 30% of the width of the groove in which the studs are arranged.

Preferably, the offset between the contact surface of each stud closest to the bottom of the groove is at most equal to 50% of the maximum height of the stud, so as to promote heat exchange between the tire and the ambient air.

In the case where the tread exhibits a preferred running direction, it is advisable to provide at least one groove with a plurality of studs, each stud comprising at least three contact surfaces, said contact surfaces being stepped relative to the running surface, the contact surface closest to the start of contact—taking account of the preferred running direction—being the closest to the running surface in the new, unworn state.

The variants which have been described above may be easily combined together by the person skilled in the art seeking an improvement in the irregular wear performance of a heavy vehicle tire.

Other features and advantages of the invention are revealed by the description made hereafter with reference to the appended drawings, which show a number of embodiments of the subject matter of the invention by way of non-limiting example.

### BRIEF DESCRIPTION OF THE DRAWINGS

FIG. 1 shows a partial view of a tread pattern of a tire tread, of which at least one groove comprises a device according to the invention;

FIG. 2 shows a sectional view along line II-II of the tread pattern shown in FIG. 1;

FIG. 3 shows a second variant of the device according to the invention;

FIG. 4 shows a third variant of the device according to the invention.

### DESCRIPTION OF THE PREFERRED EMBODIMENTS

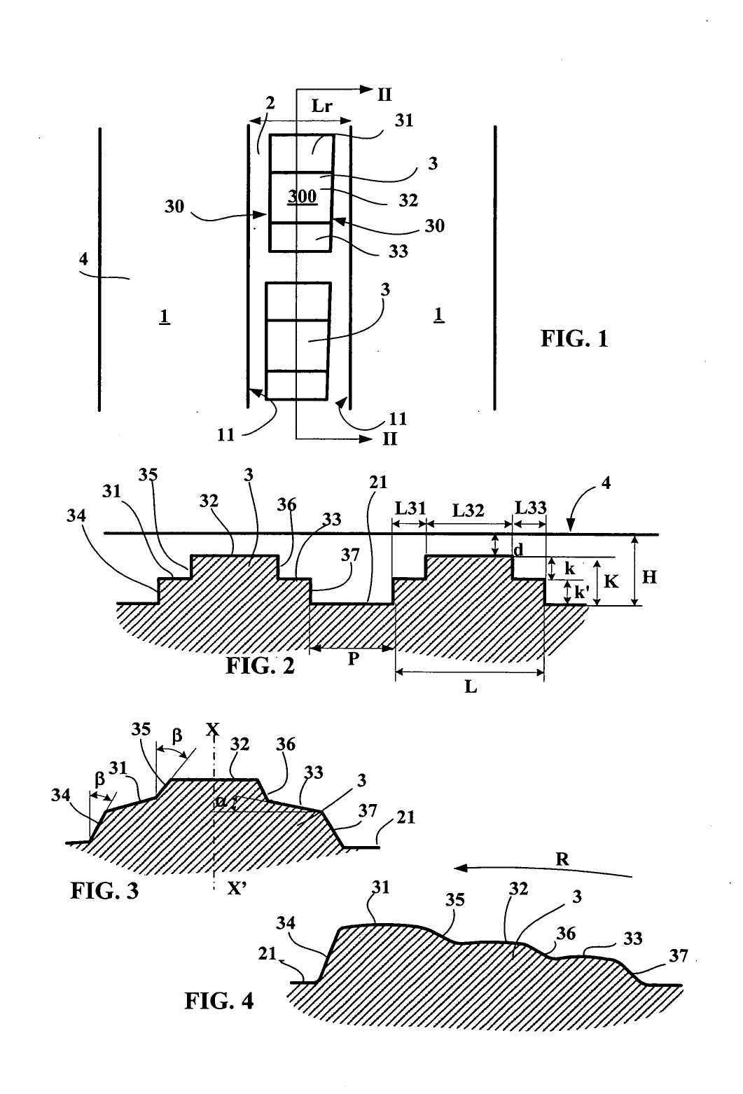

FIG. 1 shows an elevational view of part of a tread pattern of a tire of dimension 315/70R22.5. In this view, two ribs 1 of circumferential orientation are shown, of a width of 30 mm in the example shown, defining a groove 2 of a depth H of 14.5 mm and a width of 14 mm. The ribs 1 form with their radially outer surface a running surface 4 intended to be in contact with the roadway during travel. In the groove 2, there are located a plurality of studs 3 composing a device for preventing the appearance of irregular wear at the edges of the ribs 1 on either side of the studs. These studs 3 are all substantially of the same size and are distributed uniformly in the circumferential direction. The studs may be placed indiscriminately between any two ribs or rows of elements of a tread pattern and in particular in at least one of the grooves closest to the edges of a tread.

In the example described, each stud 3 comprises an outer surface formed by two lateral surfaces 11 each facing the lateral walls of the ribs 1 as well as a surface radially to the outside 300. The surface radially to the outside 300 is intended to come into contact at least in part with the roadway during travel. This outer surface 300 is formed of a plurality of contact surfaces 31, 32, 33 parallel to the running surface 4 of the tread and linking surfaces 34, 35, 36, 37 perpendicular to the running surface 4, said parallel and perpendicular surfaces being disposed alternately. The contact surfaces intersect the linking surfaces to form edges which are oriented in a direction perpendicular to the main direction of the groove.

In FIG. 2, which shows a partial, sectional view along a line II-II shown in FIG. 1, two studs 3 are shown which are molded onto the bottom 21 of the groove 2, each stud 3 having a base, corresponding to the part of the stud at the bottom of the groove, of a circumferential length designated L and equal in the present case to 24 mm. The studs of identical geometry are arranged uniformly in the circumferential direction with a pitch P equal to 28 mm (which, for the selected dimension, represents a total number of studs of 108). The width of the studs, measured in the direction of the width of the grooves, is greater than 30% of the width of the groove; the width of the studs is here 6 mm.

The surface radially to the outside 300 of each stud 3 comprises a succession of contact surfaces 31, 32, 33 which are substantially parallel to the running surface 4 and, alternately therewith, linking surfaces 34, 35, 36, 37 which are themselves perpendicular to said running surface 4.

The contact surface 32 is closest to the running surface and is offset radially towards the inside relative to this surface by a distance d.

The other contact surfaces 31 and 33, situated on either side of the surface 32, are offset radially towards the inside relative to the contact surface 32 closest to the running surface in the initial state. This offset k is identical for the two surfaces 31 and 33. Furthermore, these contact surfaces 31 and 32 are themselves offset by an amount k′ from the bottom 21 of the groove 2. The offset with regard to height between two contact surfaces of one and the same stud is at least equal to 25% of the maximum height of the stud: in the example described, this offset k is here equal to 50% of the height K of the stud.

The outer parts 31, 32, 33 are intended to come into contact with the roadway as the tread wears. The intermediate contact surface 32 (longitudinally between the surfaces 31 and 33) is offset by 2.4 mm relative to the running surface 4, while the other two surfaces 31 and 33 are offset by at least 7.5 mm and by at most 9.5 mm relative to the same surface. In the present case, the contact surfaces 31 and 33 situated on either side of the intermediate contact surface 32 are offset by 6 mm relative to said intermediate surface; the height K of the studs is 12.1 mm.

In the example described, the lengths of the contact surfaces 31, 32, 33 of each stud measured in the circumferential direction are as follows: L31 equals 4.5 mm, L33 equals 4.5 mm, L32 equals 14 mm. The circumferential distance P separating two studs 3 is here 5 mm.

For conventional heavy vehicle tire dimensions, the maximum length of the base of each stud (3) is at least 20 mm and at most 80 mm.

Due to the anti-wear device of the invention consisting of this plurality of studs 3, it is possible to control operation of said device so as effectively to prevent irregular wear while avoiding the risk of the appearance of offset of the contact surfaces of these devices radially towards the outside of the running surface. Thus, the surface radially furthest to the outside 32 is prevented from protruding radially on the outside of the running surface 4 after partial wear (i.e. after travel which has worn said tread over part of its thickness).

Radial direction is intended to mean, in the present document, a direction extending perpendicularly to the axis of rotation of the tire provided with this tread or more generally the direction of tread thickness. The phrase “radially towards the outside” is intended to mean towards the outside relative to the axis of rotation of the tire. A second surface is stated as being “situated radially to the outside of a first surface” if this second surface is radially further from the axis of rotation than the first surface.

In the device variant shown in section in FIG. 3, each stud is symmetrical in geometry relative to a median plane designated XX′, this plane being a plane containing the axis of rotation of the tire. The outer surface of each stud 3 consists of a succession of contact surfaces 31, 32, 33, the intermediate contact surface 32 being substantially parallel to the running surface of the tire whilst the other two contact surfaces on either side of this intermediate contact surface form angles α (alpha) with this intermediate contact surface, these angles α (alpha) being, in absolute value, at most equal to 10 degrees.

The contact surfaces 31, 32, 33, and the groove bottom surface 21 are joined together by linking surfaces 34, 35, 36, 37 forming an angle β (beta) with a perpendicular to the running surface passing through the point radially furthest to the inside of said inclined surface when viewed in the plane of FIG. 3. The angle β (beta) of these linking surfaces 34, 35, 36, 37 is, in absolute value, identical for all these surfaces, differing by zero degrees.

Preferably, the absolute value of the angle of the linking surfaces (34, 35, 36, 37) to a perpendicular to the running surface is at least 5 degrees.

In a variant which is not shown, these angles α (alpha) and β (beta) may be selected individually and in particular be adapted to a tread pattern having a preferred travel direction. Advantageously, the angles of the second and third contact surfaces on either side of the first contact surface are different, the difference between said angles being, in absolute value, at least equal to 5 degrees.

Preferably, the angles α and β of the contact surfaces and of the linking surfaces are between 0° and 45°.

In the device variant shown in section in FIG. 4, the studs 3 no longer exhibit a geometry having a plane of symmetry. These studs 3 form an anti-irregular wear device for a tread having a preferred direction of travel indicated by arrow R in the Figure. In this example, the surface radially furthest to the outside 31 is joined by an inclined surface 34 to the bottom 21 of the groove in which the studs 3 are formed. Furthermore, each stud 3 comprises two other surfaces 32, 33 substantially parallel to the initial running surface and being offset radially towards the inside by a greater amount than that by which the surface closest to the running surface is offset. In this example, the contact surfaces 31, 32, 33 intended to come into contact with the roadway are arranged in such a way that the contact surface 31 closest radially to the running surface is the surface which, in the circumferential direction, is closest to the start of contact. In fact, this contact surface 31 comprises two edges A and B which follow one another in coming into contact with the roadway, the edge A which comes into contact first corresponding to the intersection of the inclined surface 34 joining this contact surface 31 to the bottom 21 of the groove.

Linking surfaces 35, 36, 37 join the contact surfaces 31, 32, 33 and the groove bottom 21. The various examples which have just been described with reference to the Figures may easily be combined by the person skilled in the art: in particular, one variant may be implemented in a groove situated close to the edge of a tread whilst another variant may be used for at least some of the other grooves.

Likewise, the connections between the outer surfaces of the studs which have been described as being discontinuous may be improved, for example by providing connecting radii between the various surfaces.

Substantially regular arrangement of the studs means that they are arranged either regularly (with a constant pitch) or alternatively virtually regularly (the variations in pitch may be other than zero).

The invention also relates to a tire provided with any tread such as is defined above.

What is claimed is:

1. A tire tread provided with a running surface intended to be in contact with a roadway, this tread comprising a tread pattern formed by elements in relief defining at least two grooves of a width (Lr) and of generally circumferential orientation, at least one of said grooves comprising a plurality of anti-wear studs spaced substantially regularly in the longitudinal (circumferential) direction of the tread, each stud of a maximum height (H) at its base being separate from its neighbors in the groove, each stud comprising an outer surface formed of two lateral parts facing the lateral walls of the tread pattern elements and an outer surface between said lateral parts, the outer surface of each stud being formed of at least two contact surfaces intended to come into contact with the ground, these contact surfaces being offset radially towards the inside relative to the running surface and additionally being offset radially relative to one another in the direction of the height of the stud, the offset with regard to height between two successive contact surfaces of one and the same stud being at least equal to 25% of the maximum height of the stud, this tread being characterized in that each stud comprises contact surfaces having respective circumferential lengths (L31, L32, L33), the length of the contact surface closest to the running surface being between 60 and 85% of the total circumferential length of the stud measured at the base of said stud.

2. The tread according to claim 1 wherein the studs in one and the same groove are spaced from one another by a distance (P) at least equal to 2% of the average footprint length of the tire under its nominal operating conditions.

3. The tread according to claim 1 wherein the lateral parts are spaced by at least 30% of the width (Lr) of the groove in which the studs are formed.

4. The tread according to claim 1 wherein the total circumferential length (L) of each stud is at least 20 mm and at most 80 mm.

5. The tread according to claim 1 wherein each stud comprises linking surfaces joining the contact surfaces offset radially relative to one another in the direction of the height of the stud, these linking surfaces being inclined by a mean angle at least equal in absolute value to 5 degrees formed with a perpendicular to the running surface.

6. The tread according to claim 1 wherein each stud comprises three contact surfaces, a first contact surface being closest to and substantially parallel to the running surface of the tread in the new, unworn state, the other two contact surfaces forming with the first contact surface angles of, in absolute value, at most 10 degrees.

7. The tread according to claim 1 wherein this tread has a preferred running direction and wherein, at least in one groove, each stud comprises at least three contact surfaces, said contact surfaces being stepped relative to the running surface, the contact surface closest to the start of contact—taking account of the preferred running direction—being closest to the running surface in the new, unworn state.

8. A tire for a heavy vehicle wherein it comprises a tread defined according to claim 1.

9. The tread according to claim 8 wherein the studs in one and the same groove are spaced from one another by a distance (P) at least equal to 2% of the average footprint length of the tire under its nominal operating conditions.

10. The tread according to claim 8 wherein the lateral parts are spaced by at least 30% of the width (Lr) of the groove in which the studs are formed.

11. The tread according to claim 8 wherein the total circumferential length (L) of each stud is at least 20 mm and at most 80 mm.

12. The tread according to claim 8 wherein each stud comprises linking surfaces joining the contact surfaces offset radially relative to one another in the direction of the height of the stud, these linking surfaces being inclined by a mean angle at least equal in absolute value to 5 degrees formed with a perpendicular to the running surface.

13. The tread according to claim 8 wherein each stud comprises three contact surfaces, a first contact surface being closest to and substantially parallel to the running surface of the tread in the new, unworn state, the other two contact surfaces forming with the first contact surface angles of, in absolute value, at most 10 degrees.

14. The tread according to claim 8 wherein this tread has a preferred running direction and wherein, at least in one groove, each stud comprises at least three contact surfaces, said contact surfaces being stepped relative to the running surface, the contact surface closest to the start of contact—taking account of the preferred running direction—being closest to the running surface in the new, unworn state.
